(19) United States
(12) Patent Application Publication
(10) Pub. No.: US 2025/0141371 A1
(43) Pub. Date: May 1, 2025

(54) TIRE WITH ELECTRICAL GENERATION

(71) Applicant: GM GLOBAL TECHNOLOGY OPERATIONS LLC, Detroit, MI (US)

(72) Inventors: Walter A. Kargus, IV, Livonia, MI (US); Gaurav Talwar, Novi, MI (US)

(73) Assignee: GM GLOBAL TECHNOLOGY OPERATIONS LLC, Detroit, MI (US)

(21) Appl. No.: 18/494,762

(22) Filed: Oct. 25, 2023

(51) Int. Cl. H02N 2/18; B60B 9/26; B60B 19/00; B60C 7/14; B60L 53/57; B60L 58/12

(52) U.S. Cl. CPC H02N 2/186; B60B 9/26; B60B 19/00; B60C 7/146; B60L 53/57; B60L 58/12

(57) ABSTRACT

An electric generation system for vehicular applications including a vehicle tire having a tread portion, a hub portion and a plurality of semi-rigid spokes extending radially from the hub portion to the tread portion, a plurality of piezoelectric devices affixed to at least one surface of each of the plurality of semi-rigid spokes such that a deformation of the tread portion of the vehicle tire results in a deformation of at least one of the plurality of spokes and at least one of the plurality of piezoelectric devices, and a charge accumulator for receiving an electric current generated in response to the deformation of the at least one of the plurality of spokes and for storing an electric charge accumulated in response to the electric current.

### INTRODUCTION

The present disclosure generally relates to a vehicle tire with integrated flexible piezoelectric materials for generating electric currents, and more particularly relates to a method and apparatus for providing a tire with a plurality of flexible piezoelectric ribs added to the inside of the tire with conductive leads coupled to a battery charging circuit.

During normal operation of a vehicle, energy from the battery or motor is converted to kinetic energy to drive the powertrain, provide heat or cooling to the vehicle cabin, or to power electronic devices such as controllers or entertainment systems. Some of this energy ends up being converted to excess heat or kinetic energy which is not used advantageously, such as heat lost using friction brakes. Capturing this energy and using it to recharge batteries or to power other electrical systems has been used in electric vehicles to help to extend the range of the vehicle. This energy capture can also be beneficial for conventional vehicles, as it can improve fuel efficiency and reduce emissions by reducing the load on engine driven electric generators. In order to improve the efficiency of vehicles, and in particular the range of electric vehicles, it is desirable to use energy as efficiently as possible and to reduce any energy waste in order to provide systems and methods for vehicle propulsion and driver assistance systems. Furthermore, other desirable features and characteristics of the present disclosure will become apparent from the subsequent detailed description and the appended claims, taken in conjunction with the accompanying drawings and the foregoing technical field and background.

### SUMMARY

Disclosed herein are vehicle control methods and systems and related electrical systems for provisioning vehicle propulsion systems, methods for making and methods for operating such systems, and motor vehicles and other equipment such as aircraft, trucks, buses, forklifts, construction vehicles and other electric vehicles equipped with flexible tires and electric storage systems. By way of example, and not limitation, there are presented various embodiments of systems for generating electricity using piezoelectric ribs installed to flexible vehicle tires.

In accordance with an aspect of the present disclosure, an electric generation system for vehicular applications including a vehicle tire having a tread portion, a hub portion and a plurality of semi-rigid spokes extending radially from the hub portion to the tread portion, a plurality of piezoelectric devices affixed to at least one surface of each of the plurality of semi-rigid spokes such that a deformation of the tread portion of the vehicle tire causes a deformation of at least one of the plurality of semi-rigid spokes and at least one of the plurality of piezoelectric devices, and a charge accumulator for receiving an electric current generated in response to the deformation of the at least one of the plurality of semi-rigid spokes and for storing an electric charge accumulated in response to the electric current.

In accordance with another aspect of the present disclosure wherein each of the plurality of semi-rigid spokes include a planar surface and wherein one of the plurality of piezoelectric devices is affixed to the planar surface.

In accordance with another aspect of the present disclosure wherein the charge accumulator includes a current conditioning device for generating a voltage having a constant amplitude in response to the electric current received from the plurality of piezoelectric devices.

In accordance with another aspect of the present disclosure wherein the vehicle tire is an airless vehicle tire.

In accordance with another aspect of the present disclosure wherein the charge accumulator is configured to charge an electric vehicle propulsion battery.

In accordance with another aspect of the present disclosure wherein the charge accumulator is used to power a wheel mounted electronic device.

In accordance with another aspect of the present disclosure further including a current switch electrically coupled between at least one of the plurality of piezoelectric devices and the charge accumulator to prevent a current from being coupled from the charge accumulator to the at least one of the plurality of piezoelectric devices.

In accordance with another aspect of the present disclosure further including a charging interface for displaying a charge level of the charge accumulator to a vehicle operator.

In accordance with another aspect of the present disclosure further including a current switch for decoupling at least one of the plurality of piezoelectric devices from the charge accumulator in response to a cessation of vehicle tire rotation.

In accordance with another aspect of the present disclosure, a method including the steps of providing a tread portion, a hub portion and a spoke extending radially from the hub portion to the tread portion, affixing a piezoelectric device to a surface of the spoke such that a deformation of the tread portion of the vehicle tire results in a deformation of the spoke and the piezoelectric device, and electrically coupling a charge accumulator to the piezoelectric device to receive an electric charge generated in response to the deformation of the piezoelectric device.

In accordance with another aspect of the present disclosure wherein the piezoelectric device includes ferroelectric material.

In accordance with another aspect of the present disclosure wherein the piezoelectric device includes electrostrictive materials.

In accordance with another aspect of the present disclosure wherein the tread portion is formed from a pliable elastic material and the hub portion is formed from an inextensible material.

In accordance with another aspect of the present disclosure further including the step of charging, by a charging module, an electric vehicle propulsion battery using the electric charge from the charge accumulator.

In accordance with another aspect of the present disclosure further including the steps of detecting a spin rate of the hub portion and electrically decoupling the charge accumulator from the piezoelectric device in response to the spin rate being less than a threshold value.

In accordance with another aspect of the present disclosure, conditioning an electrical current having a variable amplitude received from the piezoelectric device to the electric charge having a constant amplitude.

In accordance with another aspect of the present disclosure, detecting a charge level of the charge accumulator and electrically decoupling the charge accumulator from the piezoelectric device in response to the charge level being greater than a threshold value.

In accordance with another aspect of the present disclosure wherein electrically coupling the charge accumulator to the piezoelectric device is performed in response to a vehicle operational state being switched from a standby state to a run state.

In accordance with another aspect of the present disclosure, a vehicle wheel system including a tread surface, a wheel hub, a semi rigid spoke formed between the tread surface and the wheel hub, a piezoelectric material affixed to the semi rigid spoke operative to generate an electric charge in response to a deformation of the piezoelectric material and the semi rigid spoke resulting from a compression of the tread surface towards the wheel hub, and a battery for storing the electric charge.

In accordance with another aspect of the present disclosure wherein the battery is further configured to couple the electric charge to a wheel mounted electronic device.

### BRIEF DESCRIPTION OF THE DRAWINGS

The exemplary embodiments will hereinafter be described in conjunction with the following drawing figures, wherein like numerals denote like elements, and wherein:

FIG. 1 shows a wheel system with electrical generation in accordance with various embodiments;

FIG. 2 shows a graph illustrative of an exemplary energy generation response of the exemplary wheel system in accordance with various embodiments;

FIG. 3 shows a system for energy generation in a wheel system in accordance with various embodiments; and

FIG. 4 shows a flowchart illustrative of an exemplary method for accumulating an electric charge generated by an exemplary wheel system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application-specific integrated circuit (ASIC), a field-programmable gate array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, lookup tables, or the like, which may carry out a variety of functions under the control of one or more microprocessors or other control devices. In addition, those skilled in the art will appreciate that embodiments of the present disclosure may be practiced in conjunction with any number of systems and that the systems described herein are merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

During normal operation, a vehicle tire can flex by several inches or centimeters under load. The amount of flex in a car tire depends on a number of factors, including the tire's size, construction, and inflation pressure. Tires are intentionally designed with a certain amount of flex to assist the tire in absorbing road irregularities and maintaining contact with the ground.

The problem of increasing the range of electric vehicles can be improved by harvesting energy from the deformation caused by rolling tires. A tire incorporating energy harvesting can be used not only to increase the range of consumer vehicles, but to increase the range of commercial vehicles, such as construction vehicles or semi-trucks, military vehicles, and space lander vehicles. The working principle is to use a piezoelectric energy harvester to transform the mechanical energy into electrical energy, using what is called the direct piezoelectric effect. The piezoelectric material generates electricity when it experiences cyclic loading and unloading. The main objectives in designing an energy harvesting tire are to ensure high-power output and self-sustaining capability without affecting the environment. Currently there are around 200 piezoelectric materials that have been applied in various energy harvesting systems.

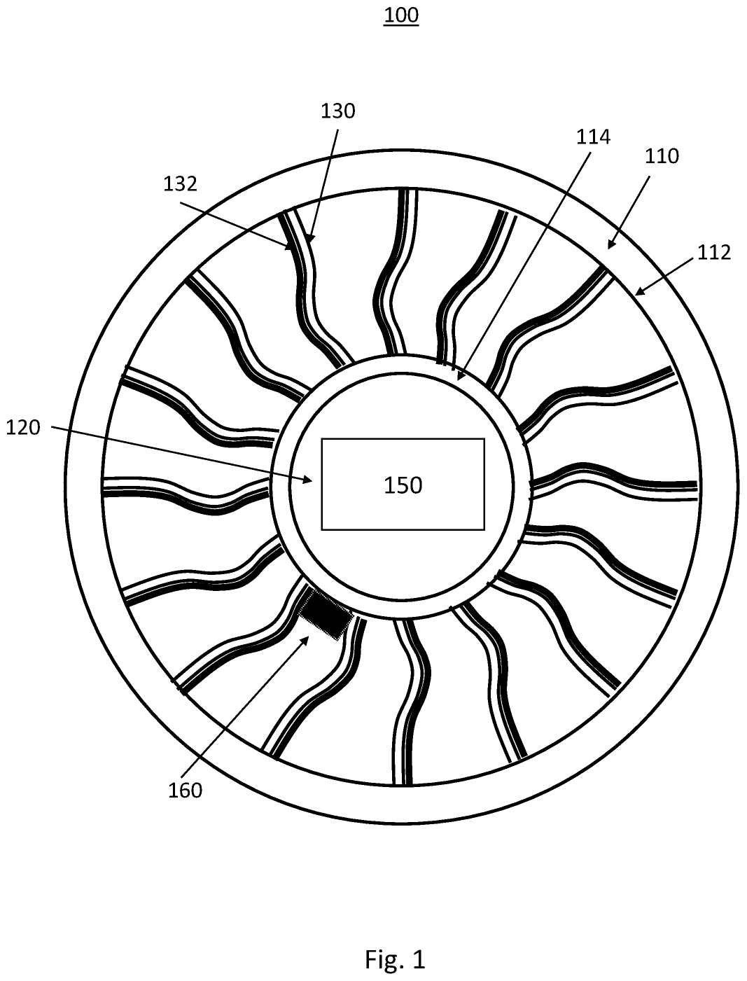

With reference to FIG. 1, an exemplary wheel system 100 with electrical generation in accordance with various embodiments is shown. In general, the wheel system 100 provides for capture, processing and storing of electrical energy generated by an incorporated piezoelectric, ferroelectric, or electrostrictive material in the ribs of a tire which are continuously loaded and unloaded as the tire rolls. The exemplary wheel system 100 is illustrated as an airless tire although the described novel system and methods can be employed with a conventional air filled tire or a tube tire. The exemplary wheel system 100 is applicable as a tire for any vehicle such as a bicycle, construction equipment or any vehicle using pliable tires.

In some exemplary embodiments, the wheel system 100 includes a tread ring 110 formed of a pliable elastic body, a hub 120 that is positioned on a tire radial direction inner side of the tread ring 110, and multiple spokes 130 that are formed of an elastic material and are for connecting the tread ring 110 and the hub 120. The tread ring 110 is a continuous annular body and has an outer surface for making ground contact and an inner surface being on an opposite side of the outer contact surface. The tread ring 110, for example, is formed of a rubber excellent in wear resistance and contains a cord reinforcing layer in the rubber. Various patterns, such as grooves, recesses, and even through holes, can be provided on the outer contact surface for discharging water of the road surface to outside of the tire. The hub 120 can correspond to a wheel rim to be mounted on a pneumatic tire and is fixed on an axle. The hub 120 can be formed of a substantially inextensible material such as steel, an aluminum alloy or a magnesium alloy. The hub 120 can have an outer surface to contact the connecting portion 114.

The multiple spokes 130 are provided along a tire circumferential direction. In some exemplary embodiments, the spokes 130 can be formed into a flat, sheet like, shape. The spokes 130 each have the outer edge that is fixed to the inner surface of the tread ring 110 and the inner edge that is fixed to the connecting portion 114 of the tire which can be fitted to an outer side of the tire hub 120. The connecting portion 114 of the tire is provided in a circumferential direction to facilitate each of the spokes 130 to be respectively more firmly connected to the tread ring 110 and the hub 120.

The exemplary wheel system 100 can be further equipped with a plurality of piezoelectric material components 132 affixed to a planar portion of the spoke 130 where the spokes 130 and the affixed piezoelectric material components 132 are situated radially between the hub 120 and the tread ring 110. In various exemplary embodiments, the wheel system 100 provides an electric charge during movement of the vehicle in response to deformation of the piezoelectric material components 132 as the tire is compressed and/or expanded during vehicle operation. The tread ring 110 and the spokes 130 are generally constructed from a pliant material, such as rubber, which flexes during operation due to the weight of the vehicle and features and obstacles of the roadway. Tires are designed to be flexible to provide a smoother ride, lower rolling resistance, provide cushioning, and to reduce wear and tear of the tire and the vehicle. Advantageously, this repetitive flexing and unflexing of the tire can be used to generate electricity by employing piezoelectric material components 132.

Piezoelectric material components 132, such as piezoelectric fibers and/or piezoelectric films, are materials that can convert mechanical energy into electrical energy and vice versa caused by the presence of a spontaneous electric polarization in the material. The polarization can be changed by applying a mechanical stress to the material. Piezoelectric fibers work by converting mechanical energy into electrical energy when they are compressed or stretched. This is known as the direct piezoelectric effect. When a piezoelectric fiber is compressed or stretched, the electric polarization changes, generating an electric voltage across the fiber. The amount of voltage generated is proportional to the amount of compression or stretching.

Piezoelectric fibers are made from a variety of materials, including piezoelectric ceramics, polymers, and composites. Piezoelectric ceramics are the most commonly used materials for piezoelectric fibers, but they are also the most brittle. Piezoelectric polymers are more flexible, but they have a lower piezoelectric coefficient. Piezoelectric composites combine the best properties of ceramics and polymers, resulting in fibers that are both flexible and have a high piezoelectric coefficient.

Some exemplary wheel systems 100 can further include a charge accumulator and a wheel mounted electronic component 160. The piezoelectric material components 132 can be conductively coupled to a charge accumulator 150 for storing the electrical energy generated in response to compression and expansion of the piezoelectric material components 132. This conductive coupling can be made by wires, printed circuit boards, or electrical traces formed on the spokes 130 or surfaces of the connecting portion 114 of the hub 120. This charge accumulator can be mounted on a rotating portion of the wheel system 100 or can be mounted on a non rotating portion of the wheel system 100, wherein the electrical energy is coupled between the rotating portion of the hub 120 and a not rotating portion of the hub via wire brushes, rotating electrical contacts, or the like.

The charge accumulator 150 can be electrically coupled to a battery charging circuit or can be electrically coupled to wheel mounted electronic component 160 for powering the wheel mounted electronic component 160. For example, the wheel mounted electronic component 160 can be one or more components of a tire pressure monitoring system (TPMS). Alternatively, the wheel mounted electronic component 160 can be a rotational sensor or the like having a wireless transmitter for communicating with an antilock breaking system or other vehicle control system.

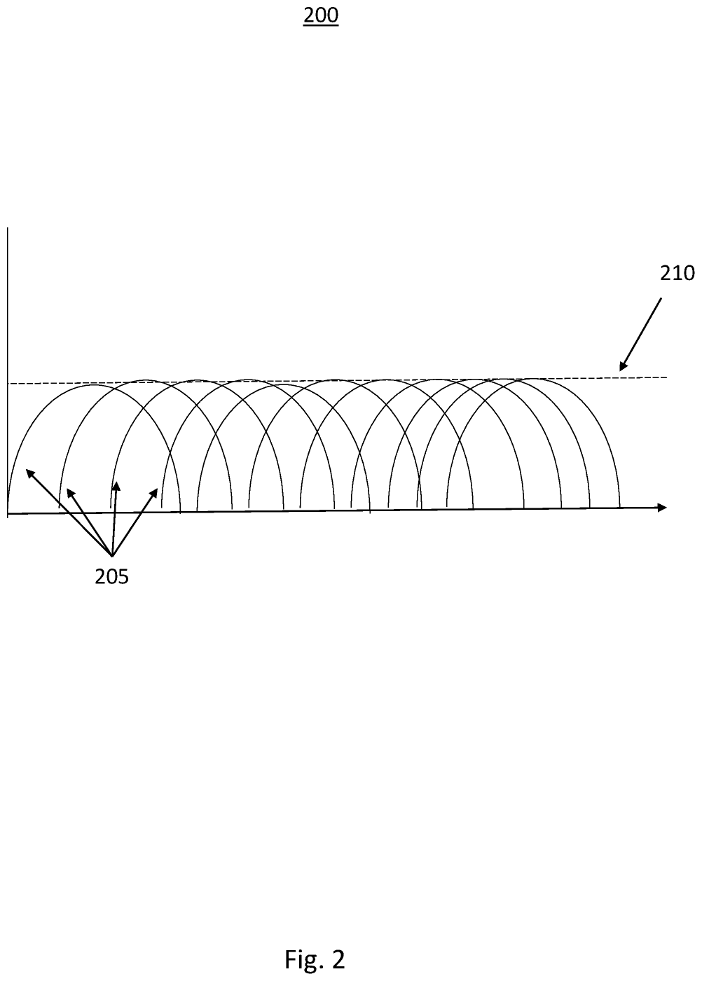

Turning now to FIG. 2, a graph 200 illustrative of an exemplary energy generation response of the exemplary wheel system in accordance with various embodiments is shown. The graph 200 shows a plurality of waveforms 205 indicative of energy generated by individual piezoelectric material components as described with respect to FIG. 1. As the tire rolls, each of the components generates energy as the corresponding spoke is compressed and expanded. The summed energy generated in response to the progressive compression and expansion of the individual piezoelectric material components can result in a generally uniform energy output 210.

The energy output from the wheel assembly can be used to extend the range of an electric vehicle or hybrid electric vehicle by capturing some of the energy that is usually lost as heat created during tire deformation. The energy generated from deforming piezoelectric material, like a tire, can be significant. In some tire configurations, a common material deformation for the wheel system can be 1.64 centimeters or more. For a tire having the following dimensions:
diameter of 64 cm, width of 20 cm, side wall of 8.2 cm,
deformed side wall of 6.6 cm and a tire patch of 296 cm².
calculated tire strain, ¿_33=0.20,
installed on a 1997 kg vehicle, a downward force of the vehicle on the tire can be determined to be 19,391 Newtons for one tire and 4,848 Newtons for four tires.

For BaTiO3, a piezoelectric material having a 4 mm perovskite structure, a piezoelectric modulus, of e_33=6.7 C_q/m\hat{ }2, a dielectric permittivity of

ϵ\hat{ }ϵ=κ\hat{ }ϵ

ϵ_0=(56)(8.8541878128×10\hat{ }(−12) F/m), a stiffness of c_33=1.51×10\hat{ }11 Pa., the voltage generated when the piezoelectric material deforms like a tire and when the material is under a similar load as the tire is first determined by determining the piezoelectric modulus as:

$${h}_{33} = β {e}_{33} = 1 \text{.351} \times {10}^{10} \frac{{C}_{q}}{F m} = 1 \text{.351} \times {10}^{10} \frac{V}{m} .$$

The voltage in response to the piezoelectric modulus due to the deformation can be determined as:

$$V = {h}_{33} Δ l = 1 \text{.351} \times {10}^{10} \frac{V}{m} 0.0164 m = 224.3 MV .$$

This large voltage can be achieved with typical tire loads for airless and pneumatic tires.

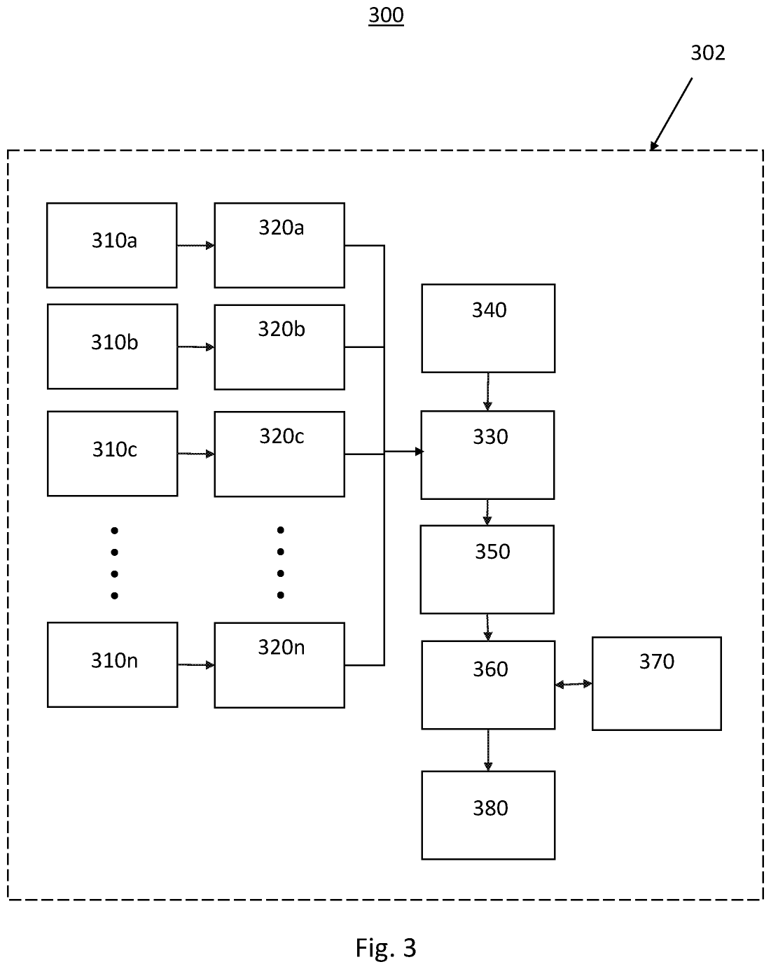

Turning now to FIG. 3, an exemplary system 300 for energy generation response of an exemplary wheel system 100 that can be incorporated into a vehicle 302 in accordance with various embodiments is shown. The exemplary system 300 can include a plurality of piezoelectric elements 310a-n, a plurality of current switches 320a-n, an interim charge accumulator 330, a wheel mounted electronics 340, an AC/DC converter 350 for voltage and current regulation, a charging module 360, a charging interface 370 and a battery 380.

The exemplary piezoelectric elements 310a-n can be piezoelectric material fibers, sheets, devices or the like and can be affixed to ribs or other tires structures connecting the wheel tread with the wheel rim for a vehicle tire. The ribs can run radially from a hub of the wheel to a inner surface of a tread portion of the wheel such that as the wheel rotates and a portion of the wheel is compressed between the hub and the tread surface on the ground. In response to this compression, the piezoelectric elements 310a-n affixed to the plurality of ribs generate an electric current in response to the compression of the tire. In some exemplary embodiments, the electric current can have a magnitude proportional to the amount of compression of the tire.

The electric current generated in response to the compression of each of the piezoelectric elements 310a-n can then be coupled to one or more of a plurality of current switches 320a-n. The current switches 320a-n can be used to protect the piezoelectric material from spurious currents generated by the other circuitry, such as the interim charge accumulator 330 as piezoelectric materials are relatively delicate and can be damaged by excessive current. A current switch 320a-n can be used to protect the piezoelectric material from damage by limiting the current that flows through it. The current switches 320a-n can also be used to isolate the piezoelectric material from the load and/or can be used to prevent back driving other piezoelectric materials causing those ribs to deform.

The current switches 320a-n are configured to conduct the electrical current between the piezoelectric elements 310a-n and the interim charge accumulator 330. The interim charge accumulator 330 can be an intermediate charge accumulator for storing energy generated by the piezoelectric devices. In some exemplary embodiments, this stored energy can be used to power wheel mounted devices or other wheel mounted electronics such as TPMSs or the like. The stored energy can also be used to replenish vehicle battery systems, such as those used in electric vehicles, by converting the stored current to a direct current (DC) current by an AC/DC converter 350 or voltage regulator for coupling to a charging module 360. n case of DC charging, the AC voltage can be rectified into DC for more effective and efficient charging boost. The charging module 360 can then be used to control that charging of the vehicle battery 380 using the DC current. The exemplary system 300 can further include a charging interface 370 for providing charging information to a vehicle operator or the like. The charging interface 370 can receive data from various vehicle sensors and controllers and can provide an estimated charge level of the battery and a corresponding range of the vehicle.

In some exemplary embodiments, the charging interface 370 can include a human machine interface (HMI), such as a uService® interface, to assemble details on the energy that has been accumulated over time. The energy can be persistently stored into the interim charge accumulator 330 until it reaches a predetermined level of charge and voltage regulated prior to being added to the electric vehicle propulsion system or battery pack. The uService interface is essentially an object, such as a protocol buffer, that would comprise the delta energy or electric power in KWH that has been garnered over the last trip, or distance interval, such as the last 100 miles or the like. The charging interface 370 can then be used to inform the driver by means of a user interface, such as a display, integral to the vehicle, an EV charging app in the vehicle infotainment system, or an EV charging app on a mobile device, such as a smartphone.

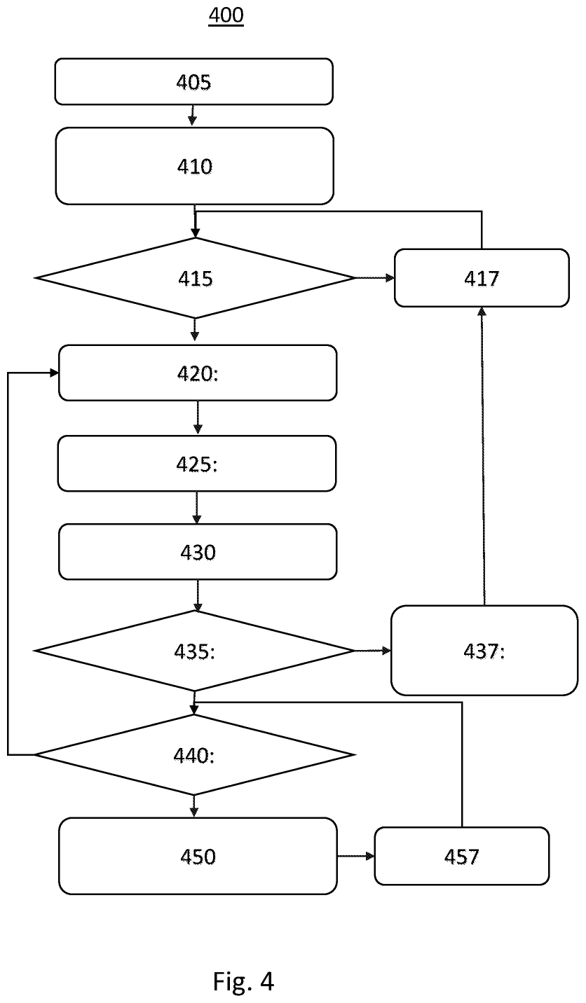

Turning now to FIG. 4, a method 400 for accumulating an electric charge generated by an exemplary wheel system in accordance with various embodiments is shown. The exemplary method can be performed by an algorithm stored in a memory, electronic media or computer readable medium and performed by a processor to control a vehicle or a vehicle system. The exemplary method 400 is first operative to receive 405 a system data from one or more vehicle data sources, indicative that the vehicle, or vehicle operating system, has been initiated. The vehicle can be determined in response to a vehicle system being changed from an off mode, to a standby mode, or from a standby mode to a run mode. In some exemplary embodiments, the initiation of the standby mode can be made in response to a start button being pressed by a driver or user of the vehicle. Initiation of a run operation can be made in response to a gear selector being moved from a park position to a drive or reverse position.

In response to a determination of vehicle initiation, the method 400 is next operative to activate 410 the wheel electric generation system. Activating the wheel electric generation system can include activation of the wheel electric generation controller and associated algorithms, can include activation of a plurality of current switches for electrically coupling the piezoelectric elements to a charge accumulator or the like.

After activation of the exemplary system, the method 400 is next configured to determine if 415 there is wheel movement. If there is no wheel movement, the method 400 can wait 417 for a period of time “t” and then redetermines if 415 vehicle movement has been initiated. The time duration of “t” can be determined in response to design criteria or operational criteria, such as computational load of the controller. In some exemplary embodiments “t” can be 1 second. In some exemplary embodiments, the value of t can be determined in response to the battery charge level. For example, if the battery charge level of the vehicle battery is low, “t” can be a shorter time duration than if the battery is fully charged and recharging is not as critical.

If vehicle movement has been initiated, the method 400 is next configured to accumulate 420 energy from the piezoelectric devices. The energy is generated in response to compression and/or expansion of the piezoelectric material affixed to ribs or other surfaces in an airless, air filled and/or tube tire wherein the compression and expansion results from deformation of the tire resulting from the weight of the vehicle and objects between the tire tread and the road surface.

The accumulated energy is next converted 425 to a DC voltage by an AC/DC converter or the like. Due to the nature of the compression of the tire, the compression of the piezoelectric material will not be uniform, thereby resulting in a non-uniform voltage amplitude being generated. As shown in the graph of FIG. 2, the voltage from each of the piezoelectric material components distributed radially around the wheel will increase from zero volts when fully expanded to a peak voltage at maximum compression. These peaks will be distributed in time and can be combined to generate an oscillating voltage. The method 400 is operative to condition this voltage with the AC/DC converter or a filter to reduce the ripple to generate an output voltage with a substantially stable amplitude.

The method 400 is next configured to charge 430 the battery with the conditioned output voltage. DC battery chargers typically work by using a switching power supply to generate a pulse width modulated (PWM) voltage to convert the input voltage to the desired output voltage. The switching power supply generates the PWM voltage by using transistors to quickly switch the input voltage on and off at specific time intervals to generate the desired DC output voltage. This allows the power supply to generate a wide range of output voltages from a single input voltage. Once the input voltage has been converted to the desired output voltage, the charger can then begin to charge the battery. The charger will typically deliver a constant current to the battery, and the battery will draw as much current as it needs. Alternatively, the DC voltage can be supplied to a charge accumulator, such as a battery or capacitor, to power an electronic device or circuit within the wheel, such as a TPMS, a wheel spin sensor or the like.

After, or concurrently with, charging the battery, the method 400 next determines if 435 the vehicle is still in motion. Vehicle motion can be determined in response to output signals from accelerometers, global positioning sensors, wheel spin sensors, motor or gear rotational sensors or the like. If the vehicle is not in motion, the method 400 stops 437 the accumulation of energy, waits 417 a time “t” and redetermines if 415 vehicle movement has recommenced.

If 435 the vehicle remains in motion, the method 400 next determines 440 if the battery has reached a maximum charge. If the battery has not reached a maximum charge, the method returns to accumulating 420 energy from the piezoelectric device. If the battery has reached a maximum charge, the method 400 deactivates 450 the wheel electric generation system. In some exemplary embodiments, after deactivation of the wheel electric generation system, the method can wait a period of time “t₂” and then redetermine if the battery is still at a maximum value. This process is repeated until the battery has discharged enough to restart charging, at which point the wheel electric generation system is reactivated and accumulation 420 of energy from the piezoelectric devices is recommenced.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An electric generation system for vehicular applications comprising:
a vehicle tire having a tread portion, a hub portion and a plurality of semi-rigid spokes extending radially from the hub portion to the tread portion;
a plurality of piezoelectric devices affixed to at least one surface of each of the plurality of semi-rigid spokes such that a deformation of the tread portion of the vehicle tire causes a deformation of at least one of the plurality of semi-rigid spokes and at least one of the plurality of piezoelectric devices; and
a charge accumulator for receiving an electric current generated in response to the deformation of the at least one of the plurality of piezoelectric devices and for storing an electric charge accumulated in response to the electric current.

2. The electric generation system for vehicular applications of claim 1, wherein each of the plurality of semi-rigid spokes include a planar surface and wherein one of the plurality of piezoelectric devices is affixed to the planar surface.

3. The electric generation system for vehicular applications of claim 1, wherein the charge accumulator includes a current conditioning device for generating a voltage having a constant amplitude in response to the electric current received from the plurality of piezoelectric devices.

4. The electric generation system for vehicular applications of claim 1, wherein the vehicle tire is an airless vehicle tire.

5. The electric generation system for vehicular applications of claim 1, wherein the charge accumulator is configured to charge an electric vehicle propulsion battery.

6. The electric generation system for vehicular applications of claim 1, wherein the charge accumulator powers a wheel mounted electronic device.

7. The electric generation system for vehicular applications of claim 1, further including a current switch electrically coupled between at least one of the plurality of piezoelectric devices and the charge accumulator configured to prevent a current from being coupled from the charge accumulator to the at least one of the plurality of piezoelectric devices.

8. The electric generation system for vehicular applications of claim 1, further comprising a charging interface configured to display a charge level of the charge accumulator to a vehicle operator.

9. The electric generation system for vehicular applications of claim 1, further including a current switch configured to decouple at least one of the plurality of piezoelectric devices from the charge accumulator in response to a cessation of vehicle tire rotation.

10. A method comprising:
providing a tread portion, a hub portion and a spoke extending radially from the hub portion to the tread portion;
affixing a piezoelectric device to a surface of the spoke such that a deformation of the tread portion of the vehicle tire results in a deformation of the spoke and the piezoelectric device; and
electrically coupling a charge accumulator to the piezoelectric device to receive an electric charge generated in response to the deformation of the piezoelectric device.

11. The method of claim 10, wherein the piezoelectric device includes at least one of a ferroelectric material and a pyrooelectric material.

12. The method of claim 10, wherein the piezoelectric device includes electrostrictive materials.

13. The method of claim 10, wherein the tread portion is formed from a pliable elastic material and the hub portion is formed from an inextensible material.

14. The method of claim 10, further including the step of charging, by a charging module, an electric vehicle propulsion battery using the electric charge from the charge accumulator.

15. The method of claim 10, further including the steps of detecting a spin rate of the hub portion and electrically decoupling the charge accumulator from the piezoelectric device in response to the spin rate being less than a threshold value.

16. The method of claim 10, conditioning an electrical current having a variable amplitude received from the piezoelectric device to the electric charge having a constant amplitude.

17. The method of claim 10, including the steps of detecting a charge level of the charge accumulator and electrically decoupling the charge accumulator from the piezoelectric device in response to the charge level being greater than a threshold value.

18. The method of claim 10, wherein electrically coupling the charge accumulator to the piezoelectric device is performed in response to a vehicle operational state being switched from a standby state to a run state.

19. A vehicle wheel system comprising:
a tread surface;
a wheel hub;
a semi rigid spoke formed between the tread surface and the wheel hub;
a piezoelectric material affixed to the semi rigid spoke operative to generate an electric charge in response to a deformation of the piezoelectric material and the semi rigid spoke resulting from a compression of the tread surface towards the wheel hub; and
a battery for storing the electric charge.

20. The vehicle wheel system of claim 19, wherein the battery is further configured to couple the electric charge to a wheel mounted electronic device.
